(19) United States
(12) Patent Application Publication
(10) Pub. No.: US 2005/0251425 A1
(43) Pub. Date: Nov. 10, 2005

(54) Method, system and apparatus for life issue tracking

(75) Inventor: Mark Adam Fox, Encinitas, CA (US)

Correspondence Address: SACCO & ASSOCIATES, PA, P.O. BOX 30999, PALM BEACH GARDENS, FL, 33420-0999, US

(73) Assignee: SOLEL SOFTWARE CORPORATION, San Diego, CA (US)

(21) Appl. No.: 11/122,605

(22) Filed: May 5, 2005

Related U.S. Application Data
(60) Provisional application No. 60/568,319, filed on May 5, 2004.

(51) Int. Cl. G06F 17/60

(52) U.S. Cl. 705/3

(57) ABSTRACT

A method of coordinating life issues and corresponding services within a life issue tracking system can include storing member profile information for each of a plurality of members of an organization, creating a life issue entry, and associating the life issue entry with a selected member from the plurality of members for which the member profile information is maintained. The method further can include scheduling at least one service to be provided to the selected member in response to the life issue entry.

### CROSS REFERENCE TO RELATED APPLICATIONS

This application claims the benefit of U.S. Provisional Application Ser. No. 60/568,319 filed in the U.S. Patent and Trademark Office on May 5, 2004, the entirety of which is incorporated herein by reference.

### BACKGROUND

1. Field of the Invention

This invention relates to the field of data processing and, more particularly, to tracking, coordinating, and managing various life cycle issues within an organization.

2. Description of the Related Art

Computer systems allow individuals to maintain large amounts of information. An information management system (IMS), for example, allows one or more users to store contact information and calendar events. The concept of an IMS has been extended to the organizational level in the form of electronic mail and/or calendaring applications. Typically, an IMS is implemented such that each user within an organization works from a client application which communicates with a centralized server over a communication network. Through the IMS, users can communicate with one another using electronic mail and other forms of communication.

Most conventional IMSs provide a general framework through which users can enter large amounts of data. Due to the significant amount of data stored, modem IMSs have largely become glorified data warehouses. While many systems seek to provide logical and efficient techniques for searching and presenting the data stored therein, little or no functionality is provided in terms of actual task or project management. Typically, the quantity of information stored within an IMS makes locating any specific piece of information difficult. When the information is found, contextual data, such as why a particular event was scheduled, often is lacking.

Another disadvantage of a conventional IMS is the inability to adapt to specific types of events and the corresponding circumstances. One type of information that a conventional IMS is not suitably equipped to handle or manage is a life issue of the variety commonly encountered by most individuals. Life issues can include, but are not limited to, happenings such as births in a family, deaths in a family, an accident, or a marriage. Typically, the data stored in an IMS is not organized to reflect such happenings or to ensure that life issues are dealt with in a time-sensitive and caring way, particularly from an organizational view point. Apart from noting the time of a meeting, for example, a conventional IMS provides no framework for following up with an individual or otherwise ensuring that the person experiencing the life issue is adjusting and/or coping with a given situation.

It would be beneficial to provide a system that is capable of tracking various life issues and which facilitates follow-through and management throughout the life cycle of such life issues.

### SUMMARY OF THE INVENTION

One embodiment of the present invention can include a method of coordinating life issues and corresponding services within a life issue tracking system. The method can include storing member profile information for each of a plurality of members of an organization, creating a life issue entry, and associating the life issue entry with a selected member from the plurality of members for which the member profile information is maintained. The life issue entry also can be associated with an affected person that has a defined relationship with the selected member. The affected person can, but need not be a member. The method also can include scheduling one or more services to be provided to the selected member in response to the life issue entry.

In another aspect, a member from the plurality of members can be automatically identified, based upon the member profile information, for performing the service(s) to be provided to the selected member. A type can be associated with the life issue entry. The type can be selected from a list of life issue types which can include, but is not limited to, birth, death, marriage, surgery, illness, accident, and/or any combination thereof.

The method also can include, responsive to the creating and/or the associating steps, selecting a caring protocol tailored to the life issue entry. The caring protocol can specify a plurality of services to be performed in response to the life issue entry. Additionally, the caring protocol can specify a date that each of the plurality of services specified by the caring protocol is to be performed. The dates can be calculated according to a date of the life issue entry. A member from the plurality of members can be identified automatically, based upon the member profile information, for performing at least one of the plurality of services specified by the caring protocol.

In yet another aspect, the method can include generating a report specifying life issues created during a specified time period. The report also can include a list of services that have been scheduled for at least one of the life issues specified within the report. An estimate of life issues to be created or services to be provided for a specified future time period also can be provided.

The method also can include receiving follow-up information relating to the performance of the service(s) and associating the follow-up information with the life issue entry. Information pertaining to one or more life issue entries can be synchronized with a remote computing device. In the event that life issue entries specify a location, the method further can include identifying life issue entries specifying a selected location and providing a list of the identified life issue entries associated with the selected location.

One or more communications can be sent to a member of the organization via facsimile transmission. The communication can be selected from a group of communications including, but not limited to, a report, a notification, and a reminder.

Another embodiment of the present invention can include a life issue tracking system configured to coordinate life issues and corresponding services. The system can include a database configured to store member profiles, wherein each member profile corresponds to one of a plurality of members of an organization, and an issue module configured to create life issues and associate each life issue with one of the plurality of members through the member profiles. Each life issue can be associated with one or more services to be provided in response to the life issue.

The system also can include a follow-up module and a reporting module. The follow-up module can be configured to receive information relating to a performance of the service(s) and associate the received information with the service(s) and corresponding life issue. The reporting module can be configured to provide an estimate of life issues to be tracked during a specified time period. The reporting module also can provide an estimate of services to be provided in response to life issues during a specified future time period.

In another aspect, a volunteer matching module and a caring protocol module can be included. The volunteer matching module can automatically select a member from the plurality of members, based upon the member profiles, for performing the service(s). The caring protocol module can select a caring protocol tailored to a specific life issue. The caring protocol can specify a plurality of services to be performed in response to the life issue and a date that each of the plurality of services specified by the caring protocol is to be performed.

The system further can include a location tracking module. The location tracking module can be configured to identify locations specified in life issues and provide a listing of members that are associated with a life issue specifying a selected location.

Yet another embodiment of the present invention can include a machine readable storage being programmed to cause one or more information processing systems to perform the various steps and/or functions described herein.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a block diagram illustrating a system for performing life issue tracking in accordance with one embodiment of the present invention.

FIG. 2 is a block diagram illustrating general functional blocks and/or modules of the Life Issue Tracking System (LITS) of FIG. 1 in accordance with one embodiment of the present invention.

FIG. 3 is a pictorial illustration of a graphical user interface (GUI) showing a listing of users and corresponding life issues which can be tracked in accordance with the inventive arrangements disclosed herein.

FIG. 4 is a pictorial illustration of a GUI showing one aspect of defining a life issue in accordance with the inventive arrangements disclosed herein.

FIG. 5 is a pictorial illustration of a GUI which can be presented responsive to a selection of the “Click Here To Add New Congregant” option illustrated in FIG. 4.

FIG. 6 is a pictorial illustration of a GUI which allows a user to define a particular type of life issue being added to the system in accordance with another embodiment of the present invention.

FIG. 7 is a pictorial illustration of a GUI which can be used to specify details of a life issue in accordance with the inventive arrangements disclosed herein.

FIG. 8 is a pictorial illustration of a GUI which can be used to present a listing of services which can be offered by an organization and coordinated through the LITS in accordance with another embodiment of the present invention.

FIG. 9 is a pictorial illustration of a GUI which illustrates another aspect of the creation of a life issue in accordance with the inventive arrangements disclosed herein.

FIG. 10 is a pictorial illustration of a GUI which can be used to present a summary view of a life issue after creation in the LITS.

FIG. 11 is pictorial illustration of a GUI showing an updated listing of life issues in accordance with one embodiment of the present invention.

FIG. 12 is a pictorial illustration of a GUI which can be used by members for creating a memorandum in accordance with the inventive arrangements disclosed herein.

FIG. 13 is a pictorial illustration of a GUI which can be used for adding a follow-up pertaining to a defined life issue in accordance with another embodiment of the present invention.

FIG. 14 is a pictorial illustration of a GUI showing another aspect of the follow-up functionality in accordance with the inventive arrangements disclosed herein.

FIG. 15 is a pictorial illustration of a GUI depicting the movement of a life issue to an inactive list in accordance with the inventive arrangements disclosed herein.

FIGS. 16A and 16B are pictorial illustrations of GUIs which can be used for presenting follow-up information pertaining to a selected life issue.

FIG. 17 is a pictorial illustration of a GUI which can be used to manipulate groups in accordance with the present invention.

FIG. 18 is a pictorial illustration of a GUI which can be used to define the services that are to be made available in accordance with the present invention.

FIG. 19 is a pictorial illustration of a GUI which can be used by selected members to access and/or run reports.

FIG. 20 is a flow chart illustrating a method of operation for the LITS in accordance with one embodiment of the present invention.

### DETAILED DESCRIPTION OF THE INVENTION

The present invention provides a solution for tracking, managing, and/or coordinating life issues. More particularly, the present invention provides a mechanism through which life issues can be tracked and/or monitored. A life issue can include, but is not limited to, an illness, a death in one's family, a divorce, a marriage, a birth, a graduation, surgery, etc. By tracking such life issues, support for the individual with which the issue is linked, or associated, can be arranged, provided, and coordinated at an organizational level. The present invention can be utilized in the context of an organization having a defined membership. Life issues of the membership can be entered into the system and tracked. The present invention ensures that as a life issue is created in the system and associated with a particular member, the status of the issue can be monitored.

In one embodiment, the present invention can be tailored for use by a religious organization such as a church, temple, mosque, or the like. It should be appreciated, however, that while many of the examples and illustrations disclosed herein are directed toward religious organizations, the present invention is not so limited. It should be recognized that the present invention can be used for a variety of different organizations, such as affordable housing and social welfare organizations, to track those issues which are most relevant to the organization.

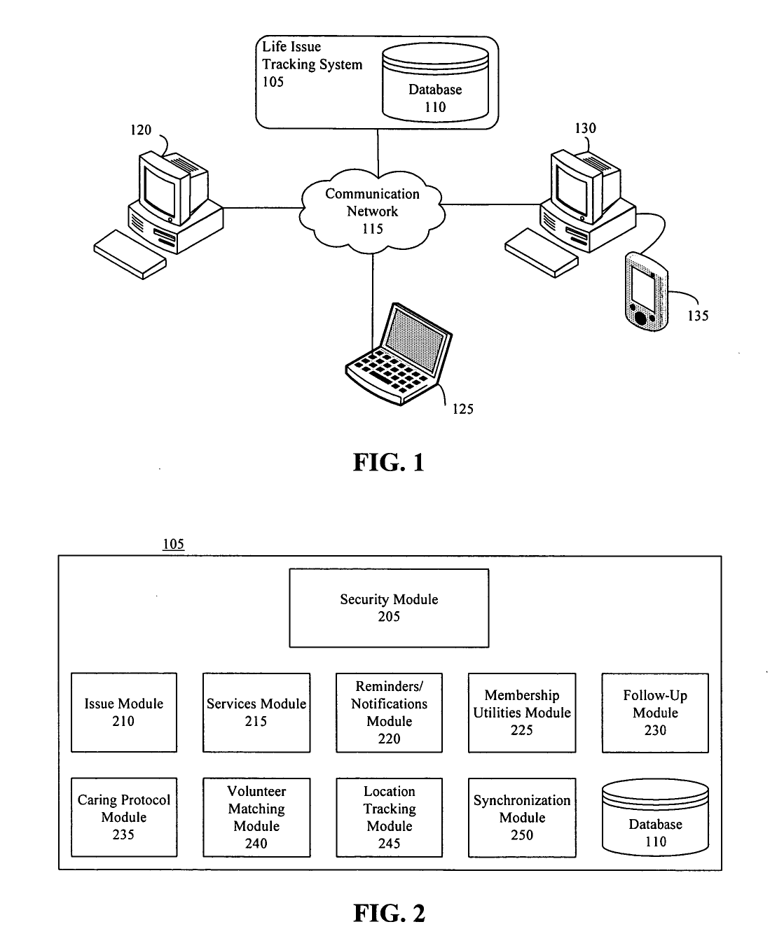

FIG. 1 is a block diagram illustrating a system for performing life issue tracking in accordance with one embodiment of the present invention. As shown, the system can include a Life Issue Tracking System (LITS) 105. The LITS 105 can be implemented as a collection of one or more computer programs or program modules, executing within an information processing system or a plurality of information processing systems, such as computer systems, servers, and/or Web servers, interconnected via a suitable communication network (not shown).

The LITS 105 can include a database 110 configured to include user or member data. The database 110 can store a profile for each user that is registered with the system, i.e. a member. Each profile can specify information such as the name of the member, a username, any passwords needed for accessing the LITS 105, contact information such as a mailing address, electronic mail addresses, telephone numbers, facsimile numbers, the user's profession, other significant experiences or qualities, and the like. Each profile also can include information relating to life issues encountered by the member.

This listing of information to be included within the database 110 is not intended to be exhaustive. It should be appreciated that any of a variety of information, including information illustrated within the various graphical user interfaces (GUIs) to be described herein, also can be included within the database 110 and/or the member profiles stored within the database 110. For example, in one embodiment, the database 110 can include information pertaining to persons that are not members of the organization. This allows the LITS 105 to track potential members, staff, and any persons to which a life issue may occur, if that person is not a member but has a relationship to the organization or one of its members. In any case, each of the life issues, as will be described herein, can be associated or linked with one or more different members to facilitate tracking of the life issue(s).

The LITS 105 can communicate with a plurality of other computing systems via a communication network 115. The communication network 115 can be implemented as a Local Area Network (LAN), a Wide Area Network (WAN), the Internet, the World Wide Web, a wireless network such as a mobile network or wireless data network, or any combination thereof. In one embodiment of the present invention, the LITS 105 can be implemented as an online or Web-based system which can be reached by a plurality of users over communication network 115.

The LITS 105 is configured to provide life issue tracking for one or more of the members enumerated in the database 110. Through the LITS 105, members of a defined class or group that are registered users can access this information to ensure that defined life issues are being dealt with in accordance with established goals, guidelines, or other policies. Each registered user, whether a member or non-member, can access various functions of the LITS 105 via remote computing systems based upon the level of access or privilege that is associated with that user.

Users can access the various functions of the LITS 105 via desktop computer systems 120 and 130 and portable computer system 125. FIG. 1 depicts a variety of different computer systems which can interact with the LITS 105. It should be appreciated, however, that the depiction of a particular type of computer system is not intended to limit the scope of the present invention, but rather to illustrate one or more aspects of the present invention. Any information processing system capable of establishing a network connection with the LITS 105 can be used. Such information processing system can, for example, execute a client application intended to interact with the LITS 105. In the case where the LITS 105 is implemented as an online service, the client application through which access is provided can be a browser capable of accessing and rendering markup language pages, i.e. Websites.

Computer system 130 is communicatively linked with a personal digital assistant (PDA) 135. The PDA 135 can communicate with the LITS 105 via the computer system 130 to synchronize and maintain a copy of the data, or any portion of the data, included within the LITS 105. This synchronization functionality allows a user to download content into the PDA 135 as well as use the PDA 135 as a data entry device and upload such content from the PDA 135 to the LITS 105.

The LITS 105 can interact with varying numbers of users at any given time. Though several computer systems are illustrated in FIG. 1, the LITS 105 can interact with more users if so desired or as needed in accordance with the size of the organization using the LITS 105. Accordingly, the depiction of a particular number of users in FIG. 1 is intended to illustrate the multi-user aspect of the present invention. As such, FIG. 1 is not intended to suggest that the LITS 105 is intended to operate with any particular, or limited, number of users or members.

FIG. 2 is a block diagram illustrating general functional blocks and/or modules of the LITS 105 in accordance with one embodiment of the present invention. The security module 205 can log registered users, or members, into and out of the LITS 105. The security module 205 also regulates member access to the different varieties of information and/or functions available within the system.

In one embodiment, within the LITS 105 members can be classified into one of three different categories: guests, normal users, and managers. Each category can be associated with a given set of privileges in terms of the type of information that can be accessed and functions that can be performed by the user within the LITS 105. Guests level users, for example, can be granted access only to life issues which have been explicitly associated with, or given to, that guest. In illustration, if a life issue within the LITS 105 is designated as being accessible by everyone, a guest will be unable to access or view that life issue unless a manager level user explicitly provides the guest with access to the life issue. Once a guest level user is granted access to a particular life issue, the guest may perform those functions associated with normal level users, but only for the specified life issue. Guests can include both member and non-member users.

Normal level users typically are individuals that provide services, but do not manage the caring process. Normal level users may view and access all unrestricted life issues. Further, functions relating to the addition of follow-up information and the sending of notifications and reminders can be performed by normal level users. By comparison, manager level users manage the caring process. As such, managers may view all life issues, whether restricted or unrestricted, and use all features of the LITS 105 in an unrestricted manner. Manager level users may add life issues to the system, remove issues, edit member profiles, and access controls to define groups and determine the level of access to be provided to another user. Manager level access typically is reserved for senior management and/or leadership positions within an organization or membership.

In another embodiment, however, an additional user category can be defined. This category can be referred to as staff. A staff level user falls between normal level users and manager level users in terms of system access. A staff level user, for example, can add, edit, and/or archive life issues, which are functions typically restricted to normal users but available to manager level users. A staff level user can be restricted, however, from accessing the control panel, which is restricted to normal level users, but available to manager level users.

The issue module 210 allows users with the appropriate level of access to create issues, edit issues, remove and/or delete issues, and place issues in an inactive list. Thus, through the issue module 210, a normal user can create an issue, such as a birth, and link that issue to a member of the organization. This allows the LITS 105 to coordinate a response to be provided to the member(s) associated with the life issue that was created.

For each different type of life issue, information describing that issue can be collected by the issue module 210 and maintained within the LITS 105, for example within the database 110. With respect to births, for example, information such as the name of the newborn, the relationship of the newborn to the member, the date of birth, place and details of the birth, the need and/or time of a bris or baby naming, any food requirements for services being provided, and the like. In the event of a death, information such as the name of the deceased, the relationship of the deceased to the member, the date of death, the cause and place of death, information about the funeral, and any food requirements for the services being provided, can be collected as part of the life issue.

The issue module 210 further can provide functions for editing the available life issues that can be tracked and defining the type of information that is to be collected for each life issue type. Thus, the particular types of life issues and information that is collected for each different type of life issue, as disclosed herein, is not intended as a limitation of the present invention as both can be highly customized within the LITS 105. This customization functionality can be restricted to manager level users.

The services module 215 can be configured to define, edit and/or delete the different services that will be offered by the organization in response to the different life issues that are tracked. This functionality also can be provided to managers. Examples of services can include, but are not limited to, providing transportation, providing meals, providing a particular religious services or functions, providing in-person visits, making telephone calls, and the like. As was the case with the issue module 210, the particular services listed herein are not intended to limit the scope of the present invention, but rather serve as illustrations of the variety of services that can be defined and offered in response to life issues.

The reminders/notifications module 220 can provide for the scheduling and sending of electronic mail reminders and notifications relating to life issues. Through the reminders/notifications module 220 members can request reminder electronic mails be sent to designated members, including themselves, and send notifications to selected members, for example when a particular service has been provided with respect to a life issue. The LITS 105, however, is not limited to sending reminders, notifications, or reports, in any particular format. For example, the reminder/notifications module 220 can be configured to send such data via facsimile, Short Message Service (SMS) for use with mobile or cellular phones or other portable computing devices, a telephone call using an automated service such as one which relies upon prerecorded prompts, speech recognition, Interactive Voice Response (IVR), and/or text-to-speech technology, or another delivery mechanism which is not based upon electronic mail.

The membership utilities module 225 allows users with the appropriate level of access, i.e. managers, to create, edit, and delete member profiles. In addition, the membership utilities module 225 supports the importation of membership profile information from other contact management and/or membership programs. The follow-up module 230 allows users to create, edit, delete, and/or view follow-up information relating to selected life issues. That is, whenever a member performs a service in relation to a life issue, information describing that service and what was provided or what transpired can be recorded as a follow-up to the life issue.

The caring protocol module 235 can create a suggested protocol for handling different varieties of life events. Once a life issue is defined, one or more services can be scheduled and assigned to different members. For example, in response to a death life event, telephone calls or in-person visits can be scheduled for the member as well as the providing of meals and other services intended to meet the needs of the member associated or linked with the life issue (hereafter the “issue owner”) within the LITS 105. The caring protocol module 235 can include a variety of programmed responses, or services, with each being assigned a location on a timeline, such that when a life issue is created, the caring protocol module 235 can suggest a protocol to be followed. The protocol will specify particular services to be performed as well as particular dates and times when such service should be offered in relation to the occurrence of a specific type of life issue.

Table 1 provides a listing of example caring protocols that can be specified and/or implemented by the caring protocol module 235. It should be appreciated, however, that new caring protocols can be defined, and existing caring protocols can be modified and/or deleted as may be required.

TABLE 1

| Life Issue | Caring Protocol |
|---|---|
| Birth | Phone Call within 5 days |
| | Card within 2 weeks |
| | Another Phone Call within 4 weeks |
| | Archive after 4 weeks |
| Death | Phone Call within 1 day |
| | Visit within 4 days |
| | Card within 1 week |
| | Another Visit within 2 weeks |
| | Another Phone Call within 4 weeks |
| | Another Phone Call after 6 months |
| | Archive after 4 weeks |
| Loss Of Job | Phone Call within 4 days |
| | Phone Call within 2 weeks |
| | Phone Call after 4 months |
| | Archive after 2 months |
| Prospective Member | Phone Call after 2 days |
| | Invitation after 1 week |
| | Phone Call within 4 weeks |
| | Phone Call within 3 months |
| | Archive after 3 months |

The volunteer matching module 240 accesses the various member profiles stored within database 110 and suggests one or more members to perform a given service or response. More particularly, the volunteer matching module 240 evaluates the member profiles and correlates that information with any defined life issues and the various services that may be scheduled for a given life issue. Each member profile, for example, can include additional data compiled from various sources such as online surveys and/or each member's history of providing particular services. The member profiles further can specify a listing of services that that member is willing to provide, i.e. transportation within a given geographic area, preparing meals or specific foods, and the like. A frequency that the member is willing to provided such services as well as availability times and/or dates also can be specified. Each member profile further can specify whether the member does not wish to provide particular services, or services to particular members, as well as those members to which the particular member would prefer providing services. This information can be referenced by the volunteer matching module 240 to automatically select and suggest potential members for providing particular services.

The location tracking module 245 tracks which members are at different locations at specified times. For example, if a member becomes hospitalized and an illness type of life issue is created for the member, the particular hospital in which the member is staying can be stored as part of the life issue. The location tracking module 245 allows qualified users to obtain a report which indicates which members are at a specific location. Accordingly, when providing a service, such as an in-person visit, a member can obtain a report of all members at a particular hospital, for example, and visit all such persons during a single trip.

The synchronization module 250 is configured to interact with remote computing devices such as laptop computers, desktop computers, and/or other portable computing devices such as PDAs. The synchronization module 250 allows selected items of information to be synchronized between the LITS 105 and the remote computing device. The particular items to be synchronized can be determined by the user performing the synchronization, within the confines of the access level associated with the user.

In one embodiment, for example, synchronization can be made available to manager level users only. In that case, each manager can specify, within his or her profile, which data items tracked by the LITS 105 are to be synchronized. As such, an organization leader can obtain a listing of life issues or other reports as described herein, which can be downloaded to a PDA. The leader can, for example synchronize with the LITS 105 to obtain a listing of services that are to be performed by the leader for a given day. As the leader performs one or more different services, such information can be entered into an application on the PDA. Accordingly, when the PDA is synchronized with the LITS 105, information originally entered into the PDA then can be uploaded to the LITS 105.

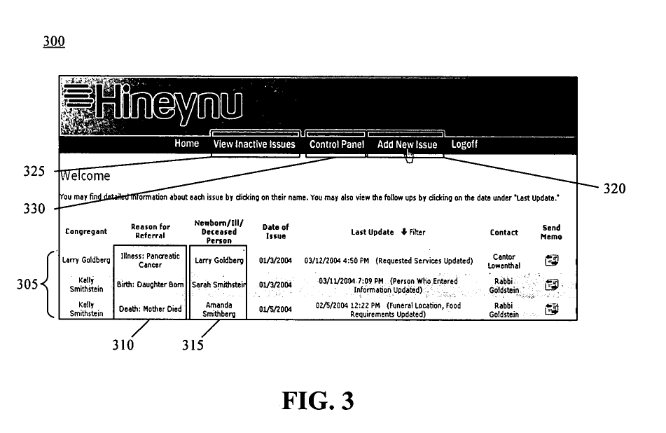

FIG. 3 is a pictorial illustration of a GUI 300 showing a listing of members and corresponding life issues which can be tracked in accordance with one embodiment of the present invention. The GUI 300 presents a sampling of the type of data that can be stored and, in one embodiment, can be presented to a member after that member logs into the LITS. As shown, the GUI 300 shows a listing of owner members 305, in this case congregants, a reason for referral or the life issue 310, a name of a person closely associated with the life issue 315 referred to as the affected person (i.e. the deceased person, ill person, if other than the owner member), and other information concerning when the life issue was first entered into the system, the status of the life issue and last update, and a contact person within the organization that has been assigned or otherwise associated with the issue for purposes of tracking and/or monitoring.

New life issues can be added to the system by selecting option 320 entitled “Add New Issue”. Selection of option 320 can cause one or more additional GUIs to be presented to the member that selected the option. The GUIs form a stepwise process facilitating the creation of a life issue within the LITS. Also, as shown, GUI 300 provides an option 325 for viewing an inactive life issue list and an option 330 for accessing a control panel. In one embodiment, the inactive life issue list corresponds to a data archiving technique which serves to reduce the size of the active data set that is processed in accordance with the present invention. In one embodiment, the features of viewing the inactive issue list and the control panel can be reserved for those members having the appropriate level of access, i.e. manager level access.

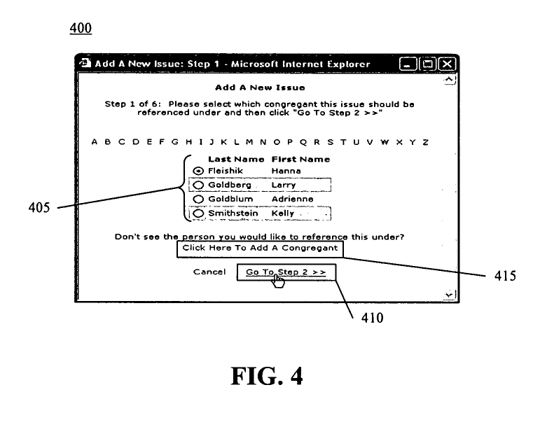

FIG. 4 is a pictorial illustration of a GUI 400 showing one aspect of defining a life issue in accordance with the inventive arrangements disclosed herein. GUI 400 can be presented responsive to a user selection of the “Add New Issue” option shown in FIG. 3. GUI 400 can present a listing of members 405 from which to choose. As noted, each life issue tracked by the LITS can be associated with a particular member, and thus, member profile. After selecting a particular member from the listing of members 405, the user can proceed to the next phase of the process by selecting option 410. Alternatively, if the particular member for which a life issue is being created does not yet exist in the LITS, option 415 can be selected so that a new member can be registered and/or added to the system. In another embodiment, the GUI 400 can include a search field (not shown) for locating a member by first and/or last name.

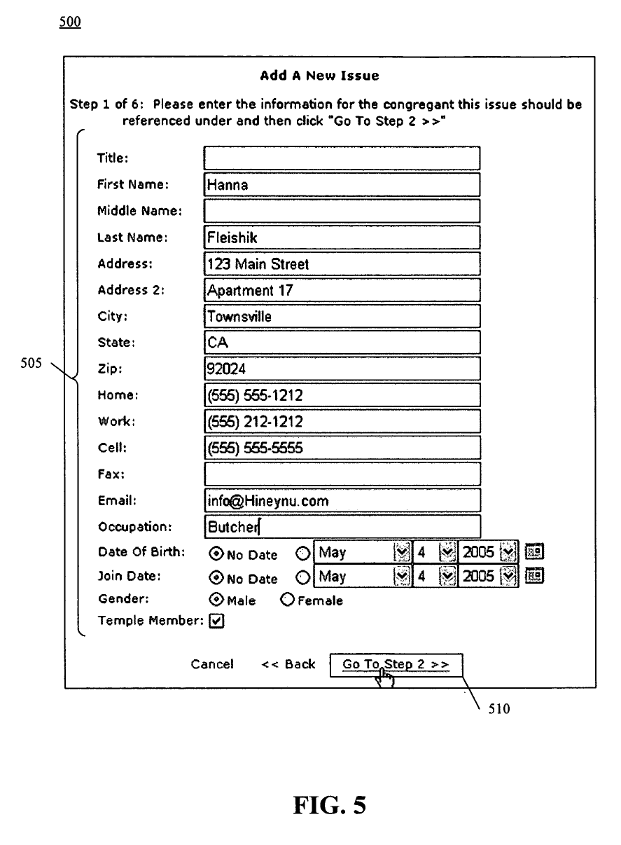

FIG. 5 is a pictorial illustration of a GUI 500 which can be presented responsive to selection of the “Click Here To Add New Congregant” option of FIG. 4. The GUI 500 includes a variety of data fields 505 which can be used to create a profile within the LITS for the new member. Once data for the member profile is entered into the data fields 505, selection of option 510 can cause the LITS to create the member profile using the data specified. It should be appreciated that the particular data fields shown are not intended as a limitation of the present invention and that other additional data fields and/or user input elements can be included.

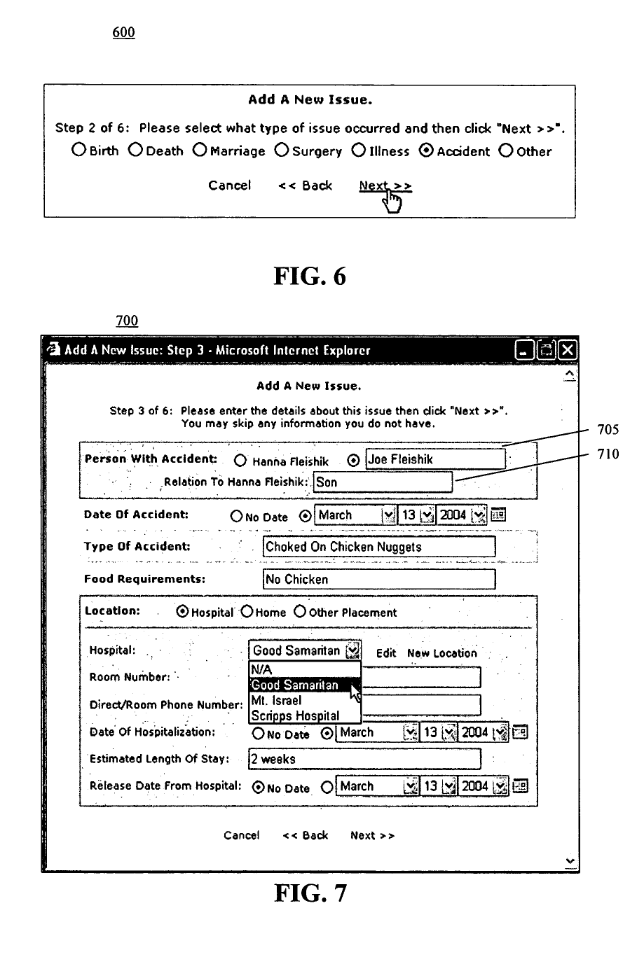

FIG. 6 is a pictorial illustration of a GUI 600 which allows a user to define a particular type of life issue being added to the system in accordance with another embodiment of the present invention. As shown, GUI 600 can present a variety, or listing, of life issue types. This list of life issue types can include, but is not limited to, birth, death, marriage, surgery, illness, accident, and/or any combination thereof. Other life issues also can be included. Users may define custom life issues by selecting “other” if the life issue is not classified as one of the listed options. The selected life issue type is associated with the member specified with respect to GUI 400 or 500 as the case may be.

FIG. 7 is a pictorial illustration of a GUI 700 which can be used to specify details of a life issue in accordance with the inventive arrangements disclosed herein. As shown, GUI 700 includes a data field 705 which indicates the person to which the life issue occurred, referred to as the affected person. In this case, the life issue, though associated with the member Hanna Fleishik, actually happened to Hanna Fleishik's son Joe Fleishik. Thus, Hanna Fleishik is the owner member, or the member with whom the life issue is associated, and Joe Fleishik is the affected person. Accordingly, the relation between the person specified in data field 705, the affected person, and the owner member can be specified in data field 710. This relationship can be any of a variety of different relationships, whether a general classification such as relative or friend, or a more specific classification such as brother, aunt, grandparent, grandchild, staff, or the like. Additional information can be obtained such as the type of accident or life event that occurred, the details of the occurrence, where the affected person is located or being cared for, and any additional details such as the length of hospital stay if applicable.

It should be appreciated that the affected person and the owner member can be the same person in cases where the owner member becomes ill or directly experiences the life issue. Also, the affected person can, but need not, be a member of the organization. As noted, the system database can include profile information pertaining to non-members. Accordingly, in one embodiment, the affected person can be a non-member that has a specific relationship to the owner member or the organization as described above, i.e. a non-member friend of a member, a non-member relative of a member, or a non-member staff person of the organization. In reference to the above example, Hanna Fleishik can be a member, but her son, Joe Fleishik need not be a member. Still, the system can include information, i.e. a profile, for Joe Fleishik. In any case, it also should be appreciated that even in the case where the owner member and the affected person are the same person, such person need not be a member of the organization. This feature allows the LITS to track issues for a staff person or a potential member, for example.

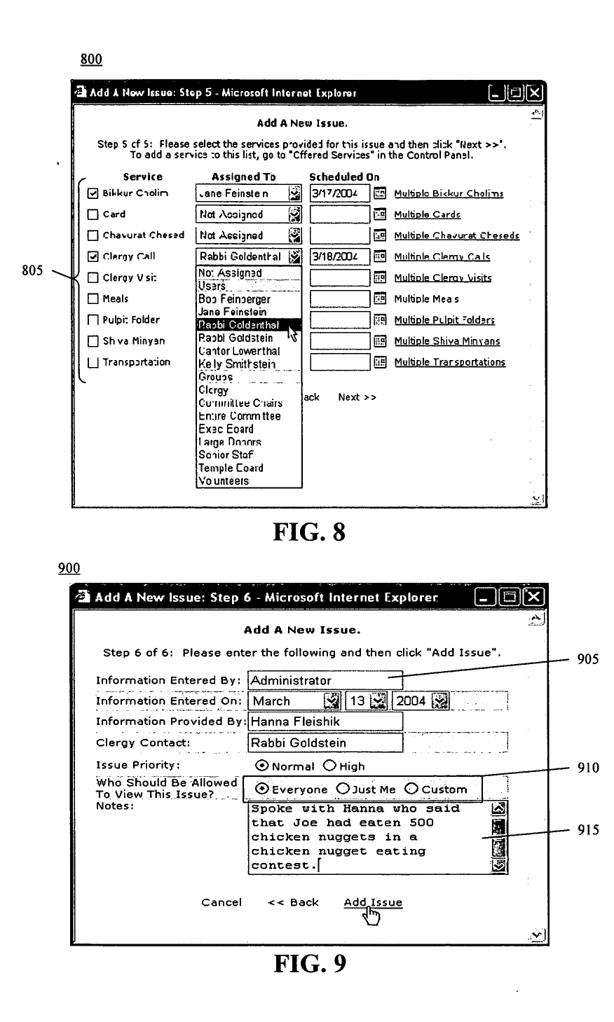

FIG. 8 is a pictorial illustration of a GUI 800 which can be used to present a listing of services 805 which can be offered by an organization and coordinated through the LITS in accordance with another embodiment of the present invention. In this case, as the organization is a religious organization such as a temple, the services offered include a clergy call, a clergy visit, meals, Shiva Minyan, and/or transportation. The listing of services 805 is not intended to be comprehensive, but rather serve as an illustration of the types of services that can be scheduled or arranged in response to different life issues tracked by the system. In any case, using GUI 800, one or more services which may be needed by the owner member or the affected person can be specified. Each service that is selected further can be assigned to a specified member. The assignment of a service to a particular person can be performed automatically, for example, by the volunteer matching module, or manually.

FIG. 9 is a pictorial illustration of a GUI 900 which illustrates another aspect of the creation of a life issue in accordance with the inventive arrangements disclosed herein. As shown, data field 905 can be used to collect information about the member that created the life issue within the system. In this case, the life issue is being created by the administrator. Option set 910 can be used to specify which members of the organization should be able to view the life issue being created. If “Everyone” is selected the life issue will be accessible by any normal or manager level user. Guests will not be provided access unless explicitly granted access to the life issue. If “Just Me” is selected the life issue will only be accessible by the person creating the life issue. No other user will have access to the issue, regardless of the status of the member. The “Just Me” status allows an individual member to create a life issue for himself or herself, for example, and be assured that the issue will remain confidential or only known to the administration, i.e. clergy.

If “Custom” is selected, a list of users and/or groups can be presented. The members and/or groups that are to have access to the life issue can be selected from the list. Any member defined as being part of a selected group will have access to the issue being created regardless of the access level of the individual user or member. If a user is added or removed from a selected group, the access of the member to the issue will be granted or denied according to the access level of the member at the time the issue is accessed. Still, it should be appreciated that any combination of individual members and groups can be selected in accordance with the inventive arrangements disclosed herein.

Additional information such as a priority for the life issue, the date the life issue was created, and a clergy contact or other administrative contact for the life issue can be collected. Life issues designated as high priority can be positioned at the top of any issue listing or summary, i.e. from a report, if so desired. Thus, if the LITS is so configured, high priority issues can be positioned above normal priority life issues even if the normal priority life issues have more recent activity than those with high priority. High priority issues also can be indicated with a special colored background, such as red, rather than the color used to indicate normal priority life issues. Still, it should be appreciated that other visual indicators can be used as well. Additional information can be entered into the notes field 915 as may be required.

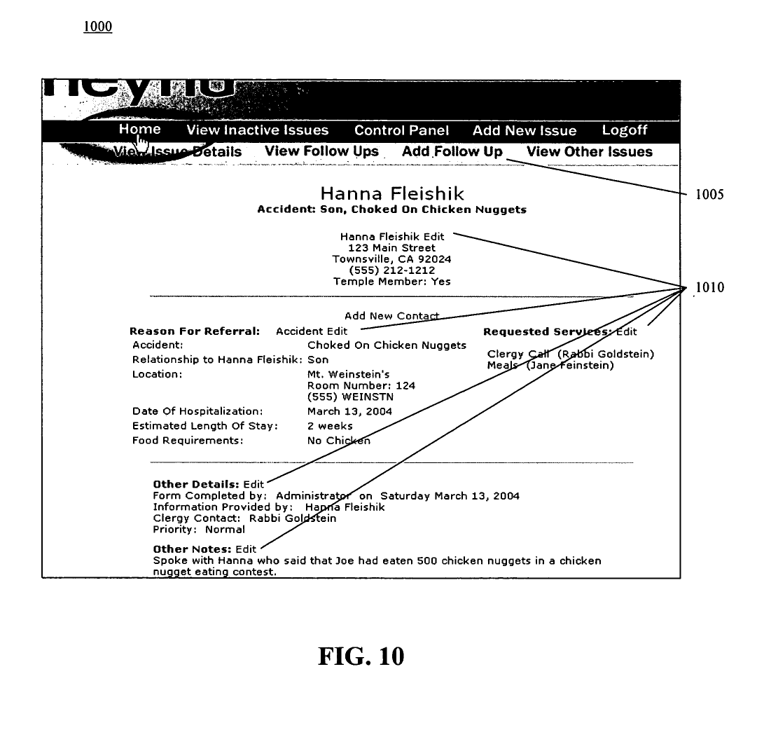

FIG. 10 is a GUI 1000 which can be used to present a summary view of a life issue after creation in the system. GUI 1000 also can function as a primary interface for adding information to an established life issue, modifying the life issue, or adding follow-up information to the life issue. In illustration, selection of option 1005 can cause a follow-up GUI to be presented which allows a member to add supplemental information pertaining to the life issue illustrated in FIG. 10. Various aspects of the life issue can be accessed and updated and/or edited by selecting the appropriate “edit” controls 1010.

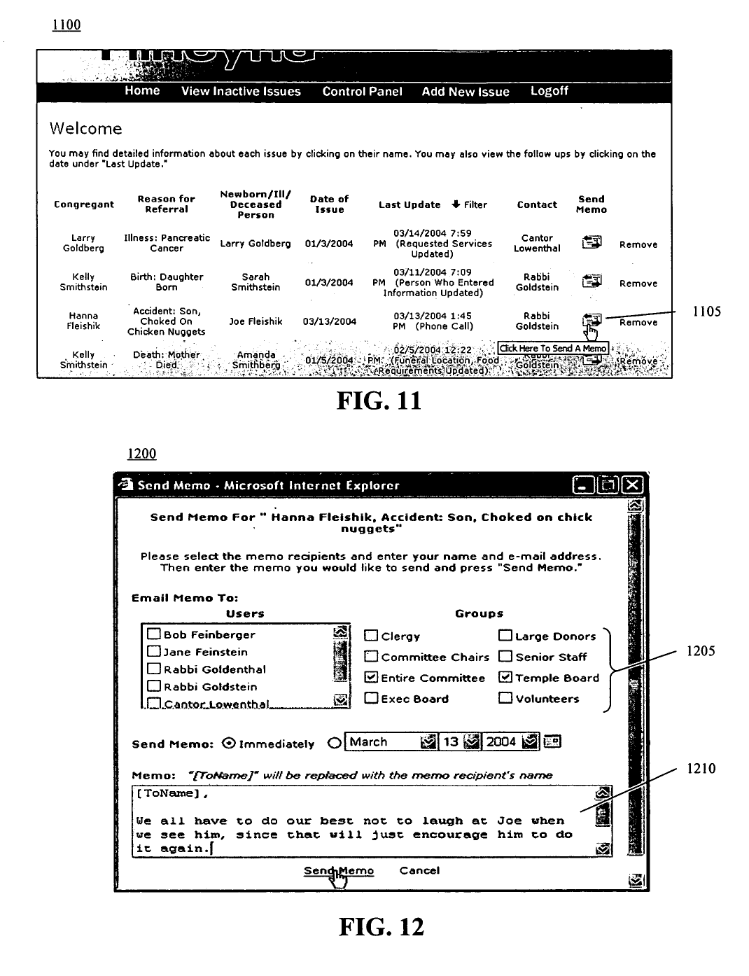

FIG. 11 is pictorial view of a GUI 1100 showing an updated listing of life issues within the LITS. As shown, the recently added issue pertaining to Hanna Fleishik is now listed among the other life issues. GUI 1100 further provides a mechanism through which members can be notified of a selected life issue. In this case, option 1105 can be selected which causes a memorandum to be distributed describing the details of the selected life issue. Here, option 1105, as it pertains to Hanna Fleishik, distributes a memorandum to a selected group of members.

FIG. 12 is a pictorial illustration of a GUI 1200 which can be used by members for selecting one or more individual members and/or distribution group(s) for a memorandum and further for adding a text description to the memorandum. GUI 1200 can include options 1205 for selecting different distribution groups. Each distribution group can specify one or more electronic mail addresses of various members belonging to that distribution group. Accordingly, each distribution group can be viewed as a subset of the larger membership of an organization. Data field 1210 can receive a text description of the life issue or any other details pertaining to the life issue for which the members of the distribution groups or lists are being notified.

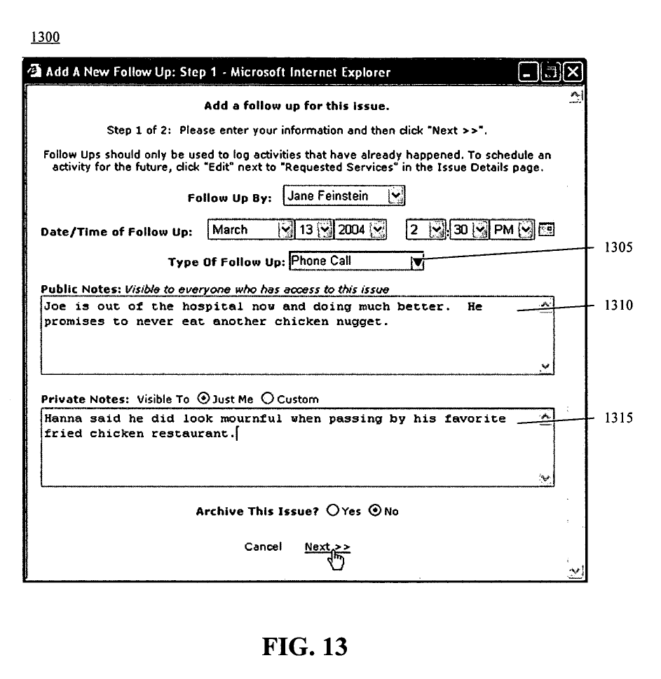

FIG. 13 is a pictorial illustration of a GUI 1300 which can be used for adding a follow-up entry pertaining to a defined life issue in accordance with another embodiment of the present invention. A follow-up entry can specify that a particular action was performed in relation to a selected life issue. Accordingly, GUI 1300 can include a data field 1305 indicating the form of follow-up that is being documented. In this case the follow-up is a telephone call. Other varieties of follow-ups can include, but are not limited to, in-person visits, delivering requested meals, providing requested transportation, etc. A data field 1310 can be included for specifying any relevant information relating to the follow-up action. Data field 1310 can be reserved for notes that will be viewable by each member having access to the life issue. Data field 1315 can be reserved for receiving notes that will be viewable only by the member that entered the notes or alternatively to a selected group of members as the case may be.

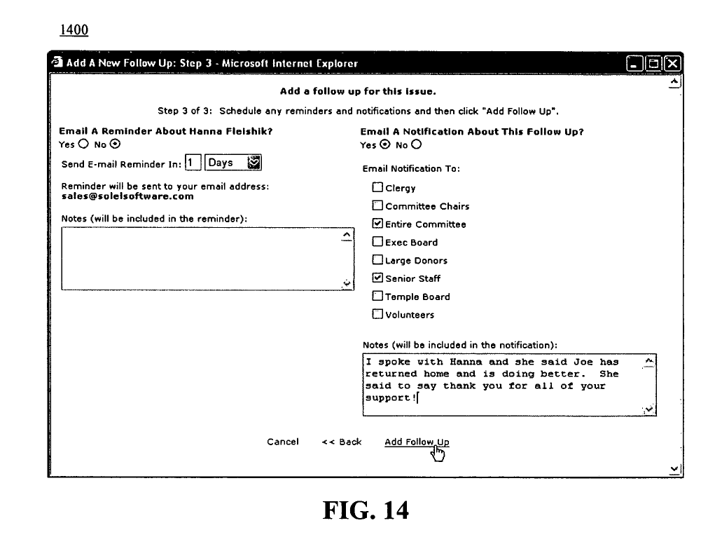

FIG. 14 is a pictorial illustration of a GUI 1400 showing another aspect of the follow-up functionality in accordance with the inventive arrangements disclosed herein. The LITS can provide reminder services to those tasked with performing a service in relation to a life issue. For each different life issue that is tracked by the LITS, one or more services can be scheduled to help the owner member and/or affected person better deal or cope with that particular life issue. Each of these services can be assigned to a particular member of the organization. Accordingly, GUI 1400 allows a member that has been tasked with providing a service to log into the LITS and schedule a reminder electronic mail notification to be sent to himself or herself.

GUI 1400 further allows a member, after having performed a particular follow-up function, to provide a notification to other members that the follow-up has been completed. Thus, if the follow-up was a telephone call, the member tasked with performing that follow-up, in this case a telephone call to Hanna Fleishik, can log into the LITS, access GUI 1400, and send a notification to one or more selected members indicating that the follow-up has been completed.

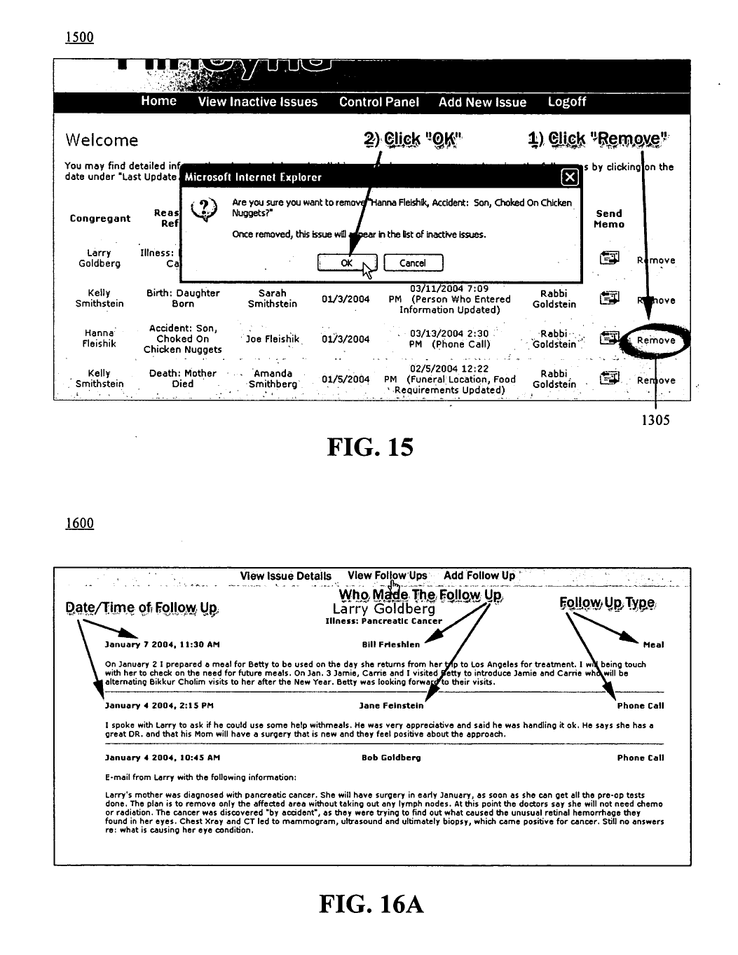

FIG. 15 is a pictorial illustration of a GUI 1500 which shows how a life issue can be removed from the system and/or added to an inactive list in accordance with the inventive arrangements disclosed herein. Selection of option 1505 for any of the listed life issues can cause the corresponding life issue to be removed from the active list and added to an inactive life issue list. The inactive life issue list can specify those life issues that have been dealt with in terms of providing any requested services to the relevant members as specified in the LITS or those life issues which are no longer active or relevant to the membership. As noted, the inactive life issue list can serve as an archival means. Though not shown, it should be appreciated that any life issues specified in the inactive list also can be re-activated such that the life issue can be tracked and/or monitored as described herein.

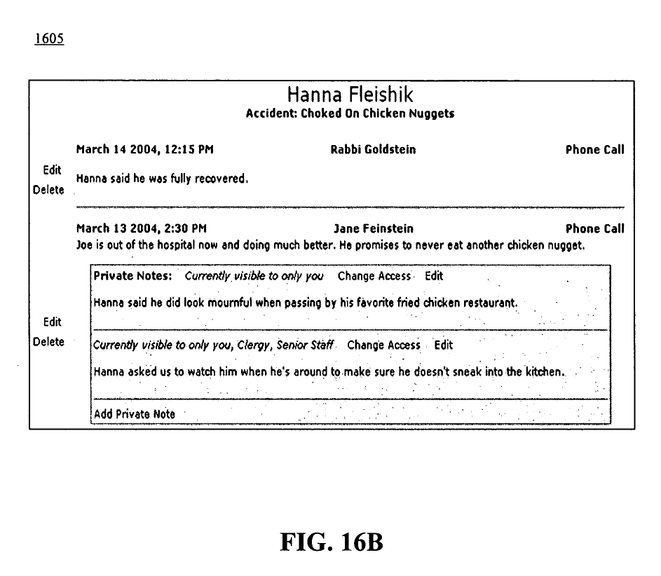

FIG. 16A is a pictorial illustration of a GUI 1600 which can be used for presenting follow-up information pertaining to a selected life issue. The GUI 1600 presents such information in list format so that a member can view the entire chain of follow-ups that have been performed in relation to a specified life issue. As shown, GUI 1600 can indicate the date and time of a follow-up, which member made the follow-up, the type of follow-up that was performed, as well as a text description of the follow-up.

FIG. 16B is a pictorial illustration of a GUI 1605 which can be used for presenting follow-up information pertaining to a selected life issue. As shown, however, GUI 1605 allows a user to change and/or edit the data that is displayed. In addition, GUI 1605 allows a member, for example one having an appropriate level of access such as manager level access, to add a private note to the life issue.

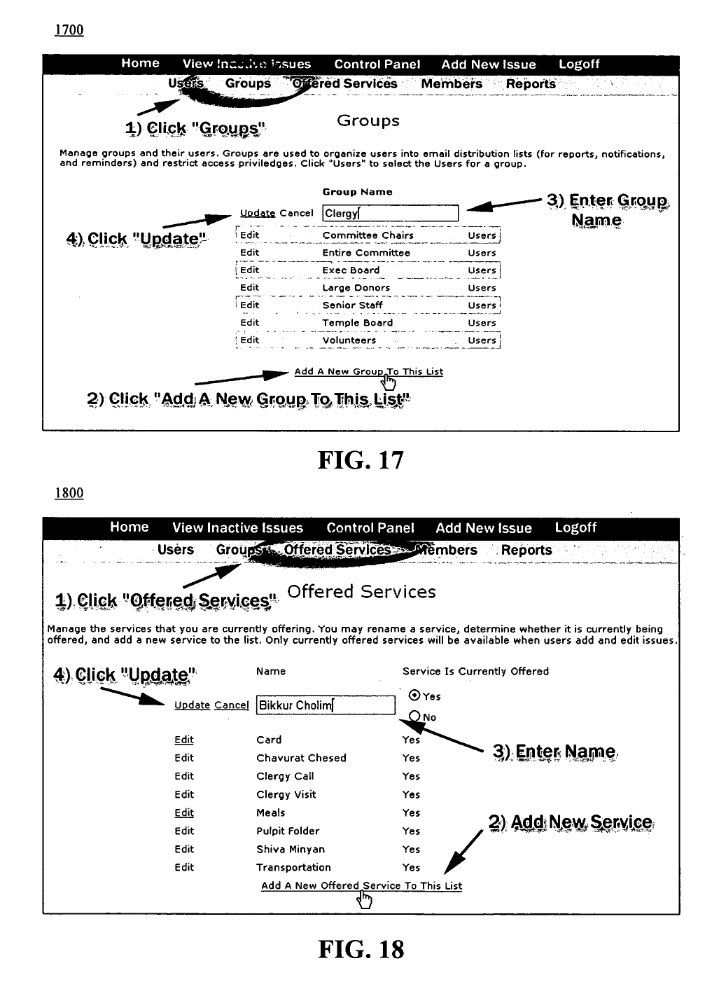

FIG. 17 is a pictorial illustration of a GUI 1700 which can be used to manipulate groups in accordance with the present invention. Though GUI 1700, members having the appropriate level of access, i.e. manager level users, can create new groups, edit existing groups, and delete groups. Groups, as used herein, can refer to a set of one or more members. Once a group is defined, various functions and/or tasks of the LITS can be assigned or performed with respect to a group, rather than individual members. For example, a group can function as a distribution list such that notifications and/or electronic mails can be sent to one or more selected groups. Reports can be run which provide data relating to a particular group. Such reports can specify statistical information for a group, such as how many services have been provided for life issues this month for a particular group, as opposed to individual members if desired.

FIG. 18 is a pictorial illustration of a GUI 1800 which can be used to define the services that are to be made available in accordance with the present invention. Through this interface, qualified members, such as manager level users, can edit existing services, delete existing services, and/or create new services. Once a service is created or modified, it is available for scheduling, i.e. to be provided as a response to a life issue. Further, the service can be included within a defined caring protocol.

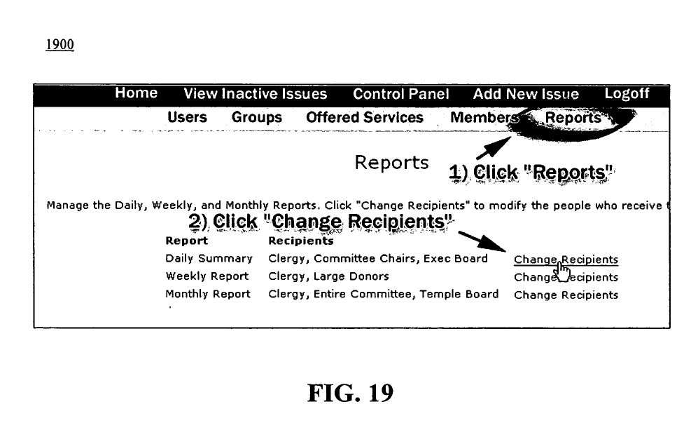

FIG. 19 is a pictorial illustration of a GUI 1900 which can be used by selected members to access and/or run reports. Though reports can be run through this interface, it also should be appreciated that manager level users can define those reports that are to be made available. In any case, the available reports can include, but are not limited to, daily summary reports, weekly reports, monthly reports, and statistics. The reports can be provided online, i.e. as a dynamically rendered Web page, or can be generated and sent via electronic mail, as an attachment or as part of the body of an electronic mail.

Daily summary reports, in general, are a variation of an issue list. Each member in the recipient groups can receive a list of the following information: the member's name, reasons for referral (life issue), name of affected person (i.e. name of the newborn, ill person, deceased person), date of the life issue, the date of the last update to the life issue, and a contact or responsible member for each life issue. Additional information which can be specified by the daily report(s) can include, but is not limited to, hospital/location, hospitalization date, release date from the hospital, and any other fields associated with the issue. The daily reports can be customized by users in terms of content to include any type of information tracked by the system. The member names listed within the report can be presented as hyperlinks which, if selected, direct the accessing member to the detailed information pertaining to the life issue within the LITS. The report also can include hyperlinks to the follow-up information pertaining to the selected life issue.

Weekly and monthly reports provide a listing of the life issues that were active during the reporting period. The life issues can be organized into four sections including new illnesses, continuing illnesses, births, and deaths. If other life issues are defined in the LITS, such life issue types also can be used as a category heading within a report. The new illnesses portion of the report can specify any life issues added during the past week or month, depending on the selected report. The report also can provide a summary of services which lists each currently scheduled service and the member that is receiving each service for the designated time period.

The LITS also provides reporting functions for statistics. The statistics that are tracked by the LITS can include, but are not limited to, the number of issues handled in a given time period, whether a week, month, year, etc., the number of members serviced in a given time period, the number of follow-ups provided in a given time period, the average number of follow-ups provided in a given time period per life issue, and the average response time between the occurrence of a life issue and a follow-up. Average response time can be further delineated based upon the type of life issue or type of follow-up or service provided in response to the life issue. For each statistic, additional information can be provided such as which members received particular services, how many members received a particular type of service, and the like.

Other more advanced statistics that can be provided by the LITS can include a historical analysis of the above statistics over time and a breakdown of the services that were provided by a particular user, group of users, or average number of services provided by each member. Such information can be presented as a chart or other graphic representation as well as in report or text form.

One example of a member information report can be a list which specifies each member's name, the number of members each member helped, the number of services the member provided, and the number of follow-ups the member performed during a specified time period. The number of members helped can be presented as a hyperlink which, when selected, displays a pop-up style window presenting more detailed information such as a list of the members helped during the specified time period. The number of services provided by each member in the report can be presented as hyperlinks, which when selected, displays a pop-up style window specifying a list of services that were provided by the member during the specified time period.

In accordance with another embodiment of the present invention, the LITS can provide forecasting functions. More particularly, with respect to the various data items tracked, forecasts can be provided in terms of expected statistics for a future time period. These determinations can be made through an extrapolation of historical data out into the future. Accordingly, example forecasting functions can include, but are not limited to, estimating the number of life issues expected, the number of service types expected to be provided (i.e. meals, transportation, etc.), and the number of a given service type (i.e. meals) expected to be provided over a specified time period extending into the future.

The various GUIs disclosed herein have been provided for purposes of illustration only. As such, the GUIs disclosed herein are not intended as a limitation of the present invention. It should be appreciated that any of a variety of different GUIs comprising various control elements, whether radio buttons, drop-down lists, or other interface elements can be used without departing from the spirit of the present invention.

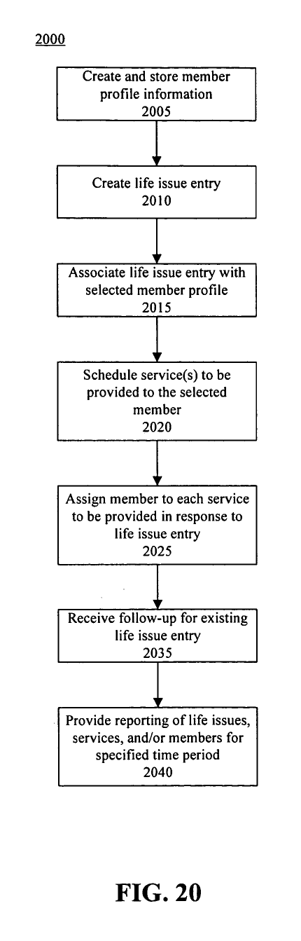

FIG. 20 is a flow chart illustrating a method 2000 of operation for the LITS in accordance with one embodiment of the present invention. In step 2005, one or more member profiles can be created and stored within the system database. As noted, each member profile can specify a level of access to the system, such as guest, normal, or manager. In step 2010, one or more life issue entries can be created. Each life issue can describe a significant event within the life of a member such as a marriage, an illness, or the like. As described with reference to the GUIs, the life issue, though corresponding to a particular member, i.e. the issue owner, can pertain to a relation and/or friend of the member, i.e. the affected person.

In step 2015, each life issue entry can be associated with a particular member from the database. Once a life issue is identified, one or more services can be scheduled in response to the life issue in step 2020. The services help the member and/or affected person cope with the life issue being tracked for the member or provide support for the life issue. In one embodiment, the service(s) can be scheduled one at a time in an manual fashion by choosing each service individually and the time such service should be rendered. In another embodiment, the services can be specified as part of a caring protocol which can be scheduled automatically in response to the creation and/or identification of a life issue within the system.

In step 2025, a member can be assigned to provide each service that is scheduled in response to a given life issue. As noted, in one embodiment, the assignment of a member to a service can be manually performed through the LITS. In another embodiment, however, the system itself can automatically match members with services, and particularly scheduled services, based upon information stored within the member profiles in the database.

It should be appreciated that at any time services are specified or persons are matched to services in an automated fashion, such decisions can be manually overridden. For example, the caring protocol can be adjusted by a member having a suitable level of access, and persons to provide services can similarly be changed, or overridden, for any particular issue and/or service. In illustration, a caring protocol can be set or established at a global level for each issue type. Thus, a caring protocol can specify that all deaths merit a telephone call within 4 weeks. This caring protocol can be overridden for any particular death issue such that despite all death issues meriting a phone call within 4 weeks, this particular death issue will receive a phone call within 3 weeks.

In step 2035, after a particular service has been performed, a member, or the member that performed the service, can make an entry within the LITS. The entry, referred to as a follow-up, provides a description of the service that was performed, whether any additional follow-up may be needed, and the like. As noted, members can choose to receive reminders regarding services for which the member has been scheduled to perform as well as send notifications pertaining to the entry of a follow-up within the system.

In step 2040, one or more reports can be provided within the system. The reports can specify any of a variety of information relating to life issues, services, and/or members. The reports can specify information for a specified time period whether in the past, or as an estimate of expected issues and/or services to be provided in the future.

The various steps described herein, particularly with reference to FIG. 20, have been provided for purposes of illustration only. Method 2000 illustrates a high level view of the various activities that can be performed in accordance with the inventive arrangements disclosed herein. One or more of the steps can be performed in varying order without departing from the spirit of the present invention. Accordingly, the method is not intended as a limitation of the present invention in any respect.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program, software, application, or any variant thereof, in the present context, means any expression, in any language, code or notation, of a set of instructions intended to cause a system having an information processing capability to perform a particular function either directly or after either or both of the following: a) conversion to another language, code, or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. Within a life issue tracking system, a method of coordinating life issues and corresponding services comprising:
storing member profile information for each of a plurality of members of an organization;
creating a life issue entry;
associating the life issue entry with a selected member from the plurality of members for which the member profile information is maintained; and
scheduling at least one service to be provided in response to the life issue entry.

2. The method of claim 1, further comprising automatically identifying a member from the plurality of members, based upon the member profile information, for performing the at least one service to be provided to the selected member.

3. The method of claim 1, further comprising associating a type with the life issue entry, wherein the type is selected from a list of life issue types comprising birth, marriage, death, surgery, illness, or accident.

4. The method of claim 1, further comprising, responsive to at least one of said creating or said associating steps, selecting a caring protocol tailored to the life issue entry, wherein the caring protocol comprises a plurality of services to be performed in response to the life issue entry.

5. The method of claim 4, wherein the caring protocol further specifies a date that each of the plurality of services specified by the caring protocol is to be performed, wherein the dates are calculated according to a date of the life issue entry.

6. The method of claim 4, further comprising automatically identifying a member from the plurality of members, based upon the member profile information, for performing at least one of the plurality of services specified by the caring protocol.

7. The method of claim 1, further comprising generating a report specifying life issues created during a specified time period.

8. The method of claim 7, further comprising including within the report a list of services that have been scheduled for at least one of the life issues specified within the report.

9. The method of claim 1, further comprising providing an estimate of life issues to be created or services to be provided for a specified future time period.

10. The method of claim 1, further comprising:
receiving follow-up information relating to the performance of the at least one service; and
associating the follow-up information with the life issue entry.

11. The method of claim 1, further comprising synchronizing the life issue entry with a remote computing device.

12. The method of claim 1, wherein life issue entries specify a location, said method further comprising:
identifying life issue entries specifying a selected location; and
providing a list of the identified life issue entries associated with the selected location.

13. The method of claim 1, further comprising associating the life issue entry with an affected person, wherein the affected person has a defined relationship to the selected member.

14. The method of claim 1, further comprising sending a communication to a member of the organization via facsimile transmission, wherein the communication is selected from the group consisting of a report, a notification, and a reminder.

15. A life issue tracking system configured to coordinate life issues and corresponding services comprising:
a database configured to store member profiles, wherein each member profile corresponds to one of a plurality of members of an organization;
an issue module configured to create life issues and associate each life issue with one of the plurality of members through the member profiles, wherein each life issue is associated with at least one service to be provided in response to the life issue;
a follow-up module configured to receive information relating to a performance of the at least one service, wherein said follow-up module associates the received information with the at least one service and corresponding life issue; and
a reporting module configured to provide an estimate of life issues to be tracked during a specified time period.

16. The system of claim 15, wherein said reporting module is further configured to provide an estimate of services to be provided in response to life issues during a specified future time period.

17. The system of claim 15, further comprising a volunteer matching module configured to automatically select a member from the plurality of members, based upon the member profiles, for performing the at least one service.

18. The system of claim 15, further comprising a caring protocol module configured to select a caring protocol tailored to a specific life issue, wherein the caring protocol comprises a plurality of services to be performed in response to the life issue and a date that each of the plurality of services specified by the caring protocol is to be performed.

19. The system of claim 15, further comprising a location tracking module configured to identify locations specified in life issues and provide a listing of members that are associated with a life issue specifying a selected location.

20. A machine readable storage, having stored thereon a computer program having a plurality of code sections executable by a machine for causing the machine to perform the steps of:
storing member profile information for each of a plurality of members of an organization;
creating a life issue entry;
associating the life issue entry with a selected member from the plurality of members for which the member profile information is maintained; and
scheduling at least one service to be provided to the selected member in response to the life issue entry.

21. The machine readable storage of claim 20, further comprising automatically identifying a member from the plurality of members, based upon the member profile information, for performing the at least one service to be provided to the selected member.

22. The machine readable storage of claim 20, further comprising, responsive to at least one of said creating or said associating steps, presenting a caring protocol tailored to the life issue entry, wherein the caring protocol comprises a plurality of services to be performed in response to the life issue entry.
